(19) United States
(12) Patent Application Publication
(10) Pub. No.: US 2013/0144430 A1
(43) Pub. Date: Jun. 6, 2013

(54) MATERIAL-LOADING CONTROL SYSTEM AND METHOD

(71) Applicants: Ya-Jun Tao, Wujiang (CN); Shu-Yen Lee, Wujiang (CN); Ching-Feng Hsieh, Taipei (TW)

(72) Inventors: Ya-Jun Tao, Wujiang (CN); Shu-Yen Lee, Wujiang (CN); Ching-Feng Hsieh, Taipei (TW)

(73) Assignees: ASKEY COMPUTER CORPORATION, Taipei (TW); ASKEY TECHNOLOGY (JIANGSU) LTD., Wujiang (CN)

(21) Appl. No.: 13/368,014

(22) Filed: Feb. 7, 2012

(30) Foreign Application Priority Data
Dec. 6, 2011 (TW) 100144819

(51) Int. Cl. B65G 43/08

(52) U.S. Cl. 700/225

(57) ABSTRACT

A material-loading control system and method are disclosed for controlling a track conveyor on a production line through a control unit. When materials are to be loaded, production information is first obtained from a production management system, and information of a tray to be loaded, information of a feeder in which the tray is loaded, and information of a corresponding station are identified. The various information are compared with the production information obtained to see whether they are matched or not. If they are not matched, the control unit is instructed to power off the track conveyor to stop the operation of the track conveyor. In addition, during subsequent production process, if a material-tossing action is detected in the production line, then the control unit is instructed to stop the operation of the track conveyor, thereby ensuring the correctness of tray changing and reducing the error rate in material loading.

### FIELD OF THE INVENTION

The present invention relates to control techniques for production lines, and, more particularly, to a material-loading control system and method for a surface mount technology (SMT) apparatus.

### BACKGROUND OF THE INVENTION

Surface mount technology (SMT) for electronic circuits mounts components with no leads or short leads onto the surfaces of printed circuit boards or other substrates through soldering techniques such as reflow or dip soldering.

In manufacturing motherboards or board cards in current SMT factories, trays containing a large amount of passive components or active components are used. During material loading performed by operators, due to human errors or ambiguous labeling, wrong material trays may sometimes be loaded. With increased mounting speed of the SMT machines, loading of the correct trays are especially important.

More specifically, a conventional material loading process involves that: an operator loads a tray into a feeder, then scans the barcodes on the tray and the feeder with a barcode scanner, and then walks to a computer to manually input the code of the feeding station, and finally returns to the platform to load the feeder into the corresponding feeding station. The disadvantage of the conventional material-loading process is that the SMT apparatus will not stop during actual operations, even if the code of the station or the barcodes of the tray or the feeder is different from the preset production information. This causes a large amount of materials being wrongly mounted and fails to ensure the correctness of tray changing.

Thus, there is a need among the SMT factories to ensure the correctness of material loading and reduces the error rate of material loading.

### SUMMARY OF THE INVENTION

In light of the foregoing drawbacks, an objective of the present invention is to provide a material-loading control system and method to ensure the correctness of tray changing.

Another objective of the present invention is to provide a material-loading control system and method to reduce the error rate of material loading.

In accordance with the above and other objectives, the present invention provides a material-loading control system connectible to a production management system and a track conveyor for controlling material loading in a production line, the material-loading control system comprising: a production management unit connected with the production management system for receiving production information about the production line obtained in the production management system, the production information at least including information of a tray to be loaded, information of a feeder in which the tray is loaded, and information of a station corresponding to the feeder; an identifying unit connected with the production management system for identifying the information of the tray, the information of the feeder, and the information of the station; a comparing unit connected with the identifying unit for comparing the information of the tray, the information of the feeder, and the information of the station identified by the identifying unit with the production information received by the production management unit and outputting a comparison signal; and a control unit connected with the track conveyor and the comparing unit for controlling the track conveyor based on the comparison signal of the comparing unit.

In the above material-loading control system, the identification unit is a barcode scanner.

In the above material-loading control system, the track conveyor includes a track motor for powering on and off the track conveyor.

In the above material-loading control system, wherein when the information of the tray, the information of the feeder, and the information of the station identified by the identifying unit do not match the production information received by the production management unit, the comparison signal outputted to the control unit instructs the control unit to power off the track motor.

The above material-loading control system further comprises a detecting unit for detecting a tossing action in the production line.

In the above material-loading control system, wherein when the tossing action is detected in the production line by the detecting unit, a signal is outputted to the control unit to instruct the control unit to stop the track conveyor.

The present invention provides a material-loading control method applicable to a production management system for controlling material loading in a production line, the production line being equipped with a track conveyor and a control unit, the material-loading control method comprising: receiving production information about the production line obtained in the production management system, the production information including information of a tray to be loaded, information of a feeder in which the tray is loaded, and information of a station corresponding to the feeder; identifying the information of the tray, the information of the feeder, and the information of the station; comparing the information of the tray, the information of the feeder and the information of the station identified with the production information obtained by the production management system and outputting a comparison signal; and controlling the track conveyor based on the comparison signal.

In summary, the material-loading control system and method according to the embodiments of the present invention controls the track conveyor through the control unit, and when materials are to be loaded by an operator, the material-loading control system identifies and compares the information of the tray to be loaded, the information of the feeder in which the tray is loaded, and the information of the station corresponding to the feeder with the production information obtained by the production management unit to see whether they are matched, and also determines whether a tossing action has occurred in the production line. If it is determined that the information of the tray, the information of the feeder, and the information of the station do not match with the production information obtained by the production management unit, or if the tossing action is detected in the production line, then the track conveyor is powered off and the operation of the track conveyor is stopped, thereby ensuring the correctness of tray changing and reducing the error rate in material loading.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram illustrating a material-loading control system according to an embodiment of the present invention; and

FIG. 2 is a flowchart illustrating a material-loading control method according to an embodiment of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

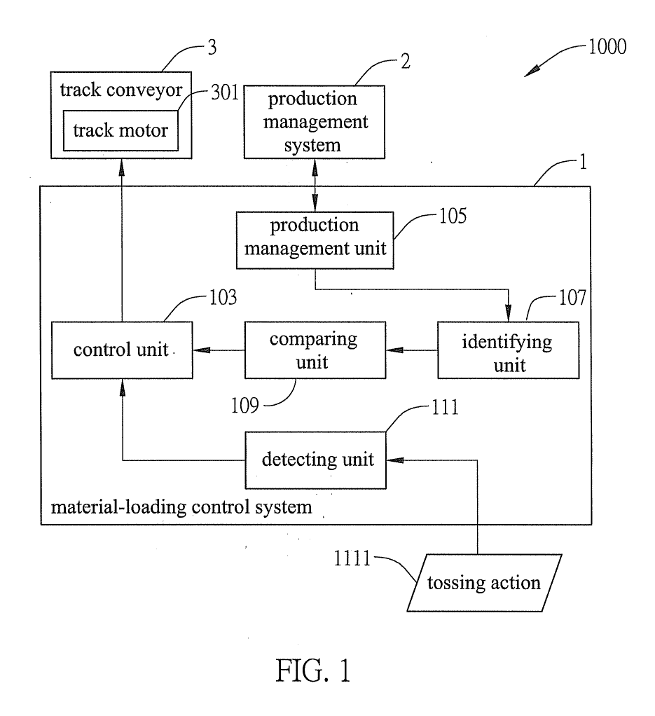

FIG. 1 is a block diagram illustrating a material-loading control system according to an embodiment of the present invention. The material-loading control system 1 is applicable to an SMT apparatus and connected to a production management system 2 and a track conveyor 3 forming a main part of a production line 1000. The material-loading control system 1 includes a control unit 103, a production management unit 105, an identifying unit 107, a comparing unit 109, and a detecting unit 111.

In addition, a track motor 301 is provided on the track conveyor 3 for powering on and off the track conveyor 3.

The production management unit 105 is connected to the production management system 2 for obtaining relevant production information about the production line 1000 from the production management system 2 in advance. In an embodiment, the production information includes information of the tray to be loaded, the information of a feeder in which the tray is loaded, and the information of a station corresponding to the feeder to facilitate in material loading by an operator of the production line 1000.

The identifying unit 107 is used for identifying the information of the tray to be loaded, the information of the feeder in which the tray is loaded, and the information of the station corresponding to the feeder for material loading by the operator. In an embodiment, the identifying unit 107 is connected with the production management unit 105 and can be a barcode scanner for identifying the information of the tray, the feeder, the station and the like by scanning barcodes thereof. In addition, other elements and methods can be used for identifying the information of the tray, the feeder, the station and the like.

The comparing unit 109 is used for comparing the information of the tray, the feeder and the station identified by the identifying unit 107 and the production information obtained by the production management unit 105. If it is determined that the information of the tray, the feeder, the station match the production information obtained by the production management unit 105, then material loading is proceeded. On the contrary, if it is determined that the information of the tray, the feeder, the station do not match the production information obtained by the production management unit 105, then a signal is outputted to the control unit 103 so that the control unit 103 powers off the track motor 301, thereby stopping the operation of the track conveyor 3.

During the production process, the detecting unit 111 detects whether a tossing action 1111 (in short, it means a material on the tray being tossed away from its original position during the production process, it is also called “material tossing”) has occurred in the production line 1000. When it is determined that there is no tossing action 1111, then subsequent operations are proceeded. On the contrary, if the tossing action 1111 is detected in the production line 1000, then a signal is outputted to the control unit 103 so that the control unit 103 powers off the track motor 301, thereby stopping the operation of the track conveyor 3.

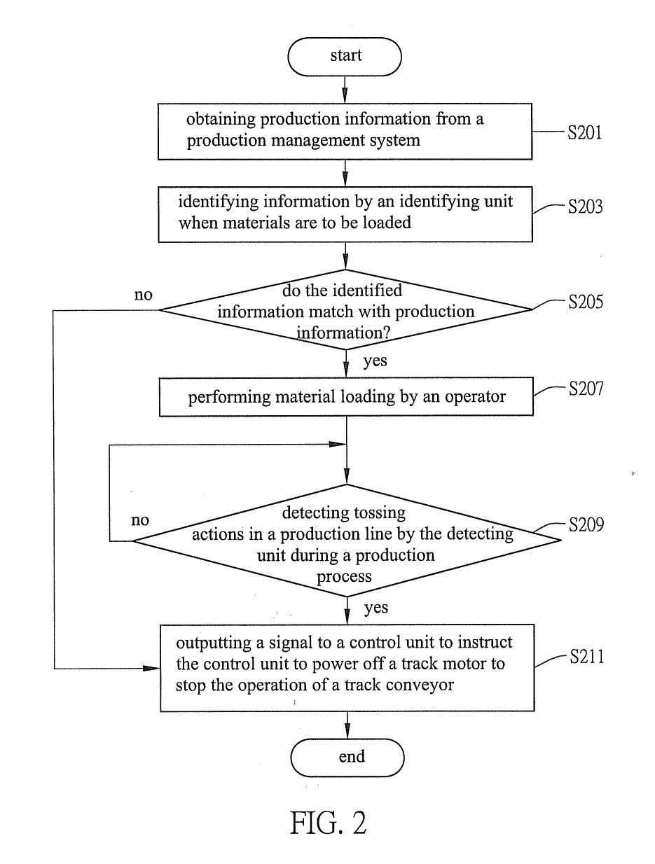

Below the flow of a material-loading control method according to an embodiment of the present invention is described with respect to FIG. 2. The material-loading control method according to the embodiment of the present invention can be applied to an SMT apparatus equipped with the material-loading control system 1. For example, the track conveyor 3 is provided on the production line 1000 of the SMT apparatus, and the track conveyor 3 is controlled by the control unit 103. In addition, the material-loading control system 1 is connected to the production management system 2 and the track conveyor 3.

In step S201, production information of the production line 1000 is obtained from the production management system 2. In an embodiment, the production information includes information of a tray to be loaded, the information of a feeder in which the tray is loaded, and the information of a station corresponding to the feeder. Then, the method proceeds to step S203.

In step S203, the information of the tray, the information of the feeder, and the information of the station for material loading are respectively identified by the identifying unit 107. In an embodiment, information such as barcodes of the tray, the feeder, the station and the like are identified by using a barcode scanner. In addition, other methods can be used for identifying the information of the tray, the feeder, the station and the like.

In step S205, the information of the tray, the feeder, and the station identified are compared with and the production information obtained by the production management unit 105. If it is determined that the information of the tray, the feeder, and the station do not match the production information obtained by the production management unit 105, the method proceeds to step S211, or else, proceeds to step S207.

In step S207, materials are loaded by an operator. Then, the method proceeds to step S207.

In step S209, during the production process, it is determined whether a tossing action 1111 has occurred in the production line 1000 by the detecting unit 111. When it is determined that there is no tossing action 1111, the method proceeds to step S211; else, step S209 is iterated until the end of the production process.

In step S211, a signal is outputted to the control unit 103 to instruct the control unit 103 to power off the track motor 301, thereby stopping the operation of the track conveyor 3.

In summary, the material-loading control system and method according to the present invention controls the track conveyor through the control unit, and when materials are to be loaded by the operator, the material-loading control system identifies and compares the information of the tray to be loaded, the information of the feeder in which the tray is loaded, and the information of the station corresponding to the feeder with the predetermined production information to see whether they are matched. If it is determined that the above information are not match, the track conveyor is powered off and the operation of the track conveyor stops. In addition, the present invention further determines whether a material-tossing action has occurred in the production line in the production process, and if a tossing action is detected in the production line, the track conveyor is immediately powered off and the operation of the track conveyor stops. The above prevention mechanisms ensure the correctness of tray changing, reduces the error rate in material loading and increases production quality.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A material-loading control system connectible to a production management system and a track conveyor for controlling material loading in a production line , the material-loading control system comprising:
a production management unit connected with the production management system for receiving production information about the production line obtained in the production management system, the production information including information of a tray to be loaded, information of a feeder in which the tray is loaded, and information of a station corresponding to the feeder;
an identifying unit connected with the production management system for identifying the information of the tray, the information of the feeder, and the information of the station;
a comparing unit connected with the identifying unit for comparing the information of the tray, the information of the feeder, and the information of the station identified by the identifying unit with the production information received by the production management unit and outputting a comparison signal; and
a control unit connected with the track conveyor and the comparing unit for controlling the track conveyor based on the comparison signal of the comparing unit.

2. The material-loading control system of claim 1, wherein the track conveyor includes a track motor for powering on and off the track conveyor.

3. The material-loading control system of claim 2, wherein when the information of the tray, the information of the feeder, and the information of the station identified by the identifying unit do not match the production information received by the production management unit, the comparison signal outputted to the control unit instructs the control unit to power off the track motor.

4. The material-loading control system of claim 1, further comprising a detecting unit for detecting a material-tossing action in the production line.

5. The material-loading control system of claim 4, wherein when the material-tossing action is detected in the production line by the detecting unit, a signal is outputted to the control unit to instruct the control unit to power off the track conveyor.

6. A material-loading control method applicable to a production management system for controlling material loading in a production line, the production line being equipped with a track conveyor and a control unit, the material-loading control method comprising:
receiving production information about the production line obtained in the production management system, the production information including information of a tray to be loaded, information of a feeder in which the tray is loaded, and information of a station corresponding to the feeder;
identifying the information of the tray, the information of the feeder, and the information of the station;
comparing the identified information of the tray, the identified information of the feeder, and the identified information of the station with the production information obtained by the production management system and outputting a comparison signal; and
controlling the track conveyor based on the comparison signal.

7. The material-loading control method of claim 6, wherein the track conveyor includes a track motor for powering on and off the track conveyor.

8. The material-loading control method of claim 7, wherein when the identified information of the tray, the identified information of the feeder, and the identified information of the station do not match the production information obtained in the production management system, the comparison signal is outputted to the control unit to instruct the control unit to power off the track motor.

9. The material-loading control method of claim 6, further comprising detecting a material-tossing action in the production line during a production process.

10. The material-loading control method of claim 9, wherein when the material-tossing action is detected in the production line, a signal is outputted to the control unit to instruct the control unit to power off the track conveyor.
